(19) United States
(12) Patent Application Publication
(10) Pub. No.: US 2022/0292069 A1
(43) Pub. Date: Sep. 15, 2022

(54) Method and System for Enhancement and Cross Relating Messages Received and Stored on a Mobile Device

(71) Applicant: Oliver Wendel Gamble, New York, NY (US)

(72) Inventor: Oliver Wendel Gamble, New York, NY (US)

(21) Appl. No.: 17/740,419

(22) Filed: May 10, 2022

Related U.S. Application Data
(63) Continuation-in-part of application No. 15/412,497, filed on Jan. 23, 2017.

(51) Int. Cl. G06F 16/22; G06F 16/25; H04L 51/42

(52) U.S. Cl. CPC G06F 16/2282; G06F 16/258; H04L 51/42

(57) ABSTRACT

Using databases and tables of records on a mobile device can enhanced utilization of text messages. Fields of a records in a table in a database on a mobile device can be used to store both incoming (received) and outgoing (sent) text messages and emails. If the records in said table have blank fields that are both editable and searchable then it is possible to store annotation and create relational records in said table in a database. This is achieved by adding fields for user entered descriptive notes to Text Messages store on a mobile device in a field labelled as annotation and adding distinct alphanumeric character strings to field labelled as Searchkey. Enabling the user of the mobile device to enhance the value of content of messages stored on the mobile device by adding clarifying notes that will help show significant of message at a later time. The ability to annotate messages when they are first encountered will enable the user to increase the relevant of a message when it is viewed at a later date. By being able to add information to the text message that may have been conveyed to the user by methods other than the Email or Text messages that is being notated.

The present application claims the benefit of priority of patent application Ser. No. 16/718,124 entitled “Method and System for Notation of Messages Stored on a Mobile Device,” filed on 17 Dec. 2019 the disclosure of which is hereby incorporated by reference in its entirety for all purposes, and patent application Ser. No. 14/541,132 entitled “Method and System for Interactive Notation and Text Data Storage with a Mobile Device” filed 13 Nov. 2014, Provisional Patent Application 61/962,697 entitled “Method and System for Interactive Notation and Text Data Storage with a Mobile Device” filed 13 Nov. 2013.

Before the present methods and systems are disclosed and described in this patent, it is to be understood that the methods and systems are not limited to specific methods, specific components, or to particular implementations. It is also to be understood that the terminology used herein is for the purpose of describing particular embodiments only and is not intended to be limiting to the scope of the patent.

### FIELD OF THE INVENTION

The present invention relates generally to a method and system for improving the ability to understand information conveyed to and stored on a mobile device in the form text messages and emails. Until now text messages and emails were just information that was generally viewed in a flat linear format that for most people was a onetime source of interest. That is the recipient of a message would read it and be done with it. Sometime a message that arrived and is stored on a mobile device importance is forgotten or overlooked, because of the time lapse between receiving and reviewing the store message. Generally, the passage of time resulted in a fading of memory, but not importance of saved the message. If you do not remember someone important saying that they will drop you a line, when that person Text message you out of the blue, you may not remember the significance of the communication and the opportunity it may represent. The more messages accumulated, and more time passes, the dimmer one's memory can become on the facts or importance of a piece of information sitting on a mobile device.

### SUMMARY OF THE INVENTION

Enclose is an improved system and method for mobile device users to manage the information contained in text and email messages, by enabling the annotation of those messages that the user feels are important and providing a way to link messages that the user feels are relevant to one another.

### SPECIFICATIONS OF THE INVENTION

To achieve better management, each received and sent email and text messages captured and stored in fields of a record in a table in a database on a mobile device. The messages are parse into various fields in the record. The table is made up of records that have specific fields to contain all of the elements of the message, and other specific fields that are initially blank fields that the user can edit and save information (string of alphanumeric characters).

A sender of a text message or email may include at the top (first line) of the email or text message a tagged. A tag is a special string of characters that indicate a specific action or function. A tag is denoted by the pound sign, but other character, or combination of character can be used (Fig. xxx). These actions and function of a flag can be to trigger a specific action such as sending a text message to the sender acknowledging receipt of an email or a text message, trigger an alert (audio, vibration, or combo of the two) when the message arrives, or at a future date.

The contents of each received message will be scanned/filtered for flags and other data contained in the text message: i.e., phone number, alert flag, reply to indicator flag, and activity triggers. Any recovered phone number, flag, and/or actionable triggers (triggers that will cause the OT application to execute a specific action at a specific time or event) will be stored in specific fields. The OT application will execute functions on these flags and phone number when determined appropriate.

One of the fields (SearchKey field) in the record (in the table of the database) that are blank is specifically created for enabling the user to link records together regardless of their content. This is achieved by providing the user with a place to store a common alphanumeric string, “SearchKey field”, in any record that they want to be associated with one another. When the user later run a search of the table for the common/shared alphanumeric string, all of the records in the table that have the same alphanumeric string in the “SearchKey field” will be displayed together. This will enable the user to assemble for consideration desired stored messages regardless of their origin and nature: emails and text messages can all be associated or be made relational to one another.

In another of the fields (annotation field) in the record in the table that are blank is specifically created for enabling the user to store notes or comments that are relevant to the message. This will allow the user to immediate store first impressions or later thoughts on the message. Once the information is stored in the “annotation field”, it can be later viewed along with the message on the same screen. In this display configuration the user will see both the saved message and the annotation on said saved message and be reminded of their first impression on the saved message or other information that at one point in time they felt was important or related to the saved message. The Annotation field will hold a large block of text. The Annotation field is accessible by the user and allows the user to type in any sort of message (a word, a string of words, or a large paragraph). The Annotation of each record/message can be called up and viewed with the press of a button when the user is viewing a message. Another extra field is labelled “SearchKey,” it is both editable and searchable by the use of the mobile device.

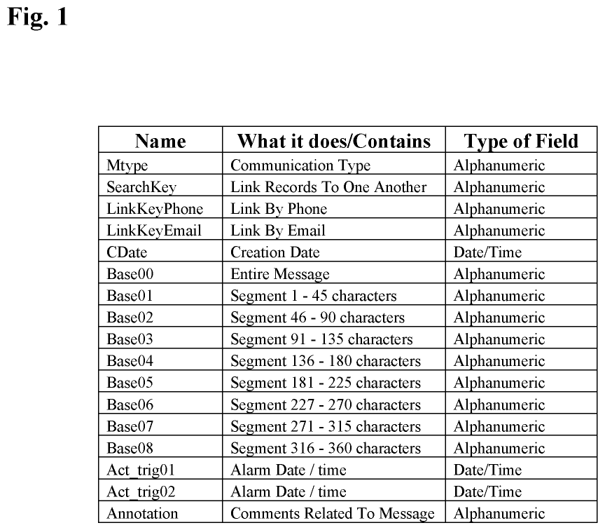

An Application that is loaded on to/into a mobile device contains a database, that contains tables, that are composed of records. Each record contains a variety of fields similar to that of FIG. 1. Once the application is installed, each sent and received text message and received email will be captured and stored in fields of an individual record of a table of a special database. The database is special in that it will allow the user mobile device store and search fields that contain information that was extracted from and converted into information, and said information is stored in specific fields of a record in a table. The fields of the records that the captured messages are stored, allow the user to selectively edit the contents of some of the fields in the record (SearchKey field and Annotation field), and enable the grouping of the messages stored in the records said table in said database. When a message is captured, it is broken down into specific parts and said parts are stored in specific fields of a record on a one-to-one ratio. That is each message regardless of its original nature, email or text message, is stored individually in a record. Specific fields in the record are both editable and searchable, while other are just searchable. The said specific fields “Annotation” and “Searchkey” are both searchable and editable. These fields are normally blank, and the user can enter whatever alphanumeric string they want. The user of the application can access and enter information into the field denoted as “Annotation” (see FIG. 1).

When an email or text message is sent or received it is converted into a string and stored in the “Base00” fields of the record: Note in some instant only received emails are converted and stored in a record. The record is stored in a table that is viewable by the user, allowing the user to view all sent and received text messages and emails in various orders (i.e. by sender, by date, by sender and date, by subject, by sender and subject, and by date and subject and by sender). When a text message is sent or received it is converted into a string and stored in the “Base00” field of the record and segmented into character strings that are sequentially store in field Base01 to Base08. The message segments are blocks of about 45 characters in length each and store in the fields labelled “Base01” to “Base08”. Normal text messages are generally in units ranging from 1 to 180 characters each, and emails can be much larger. By breaking the stored message into segments it is possible to display a fraction of the message, field “Base01” or fields “Base01” and “Base02”, on a screen that scrolls through a listing of received messages. This partial display can serve as a preview to what the message contains, and will enable the mobile device user to get a quick impression of what a given message contains and aid in deciding if they are interested in reading the whole message or just deleting it.

This is an improve method of viewing messages, the improvement saves time and energy by reducing the amount of text a user is subjected to when looking at received messages: email and text. The improvement include letting the user view both received email and text messages in a single location (application). The emails can be from multiple accounts and platform: Outlook, Gmail, and other. The record containing various messages is stored in a table that is viewable by the user, allowing the user to view all received and sent text messages and received emails in various orders (i.e., by sender, by date, by sender and date, by receiver, and by receiver and date). While viewing a stored message (email or text message), the user can click on a button to access a text box that will stores whatever is written by the user in it to the first annotation field (“Annotation”). When finish entering notes, the user can click on another button to signal finish and the content is saved by the application and the text box is closed. Since the messages are stored as records in a database format of searchable fields in a table, it is possible for the use to search the table for specific message(s), or to display the search results for messages in a specific order.

Text Messages (TM) are generally of a maximum length of 180 characters in length. The Application (OT) will store each incoming and outgoing TM in two versions in a record, one version as an entire message in a field or a record, and the second version as subdivided into 4 fields (Base01-Base04). If message is longer than 180 alphanumeric characters, then there is the additional fields (Base05-Base08). The contents of each text message is divided into segment of approximately 45 characters in length: some segments will be more than 35 characters in length, and other segments will be less than 45 characters in length. The division of the text message content will be such to avoid dividing the TM into four roughly equal length segments without splitting a word in the middle in the content of the text message, segmentation will occur in a blank space between words in the message. Each segment containing parts of a receive or send text message will be sequentially stored in specific fields in a record stored in a table store in a database. If the text message length is between 1 and 45 characters in length, the entire text message will be stored in the first field of the record; if the message is between 46 and 90 characters in length, the text message will be stored in the first and second field; if the text message is between 91 and 135 characters in length, it will be stored in the first, second, and third field; and if the text message is between 135 and 180 characters in length, the text message will be stored in the first, second, third, and forth field of the record. Each record in the table has fields that can hold both an incoming and an outgoing text message: a message and the reply to it. Each record can also have fields to hold other types of information that can be extracted from an incoming or outgoing text message (see FIG. 1). These field will can hold expiration date, creation (received/send) date, flags for executing certain activities, phone numbers, editable search key (field by which the record can be group/sorted), and other fields that are needed to perform functions the Application.

Emails are received on a mobile device in the form of files with an EML extension. Said EML files are captured and converted into string components that are storable in fields of a record. Both the records containing stored emails and stored text message are contained in the same table in the same database on the mobile device. This enable a user of mobile device to not only to be able to stroll through received messages in one location, it also allows the user to search the content of both received text messages and emails at the same time using the exact same search criteria.

The Editable “Searchkey”, is a blank field in a record of a stored message that the user can use to create a searchable attribute that can be shared between any given record storing a message in a table in a database on a mobile device. When the user of said mobile device access the various stored record in the tables, they can enter a distinct alphanumeric character string in Searchkey field. The said distinct alphanumeric character string can be searched up by the said mobile device user and the results would be all records containing the said distinct alphanumeric character string. Thus, enabling the user to create a relationship between any stored message regardless of its origin or its content, the common factor that links the records would be a shared distinct alphanumeric character string. The shared alphanumeric character string can be any word or group of words that is stored into the “Searchkey”. There will be other search options that can be selected by the user: date, phone number, name, grouping, or by any word/alphanumeric character string that the user wants to search by or for.

The OT application allows the user to search their entire text message table (database) by several different fields, of which the granular is the most efficient. The granular search will search each field of the record in the table for a record that contains the occurrence of a matching searched for alphanumeric character string.

OT application has the ability to search all of the records stored in the database on the mobile device, allowing the user to connect data from multiple origins: text messages and emails from different people can be combined and searched at the same time being that they are in the same table of the database. The newly created record in table containing the database of sent and received text messages and email can now be searched in a granular manner: all stored messages can now be searched individually for a specific word, regardless of their origin. The records created from different sources can also be cross related by the editable search key (aka: “SearchKey”).

This mean that you can search messages from different people/companies for a word (piece of information). The SearchKey can be words, numbers or a combination of the two. The user will be able to search all of their sent and received messages for a specific alphanumeric character string stored by the user in the Searchkey field, enabling them to search Text Messages and Email from multiple sources at the same time for the same wording. The database field system created under the OT system will allow users to screen incoming text message and disposition them: delete, read, and store for later actions. The editable search key allows the phone user to store the information under a word that best suits the information they are storing on their phone. Once the information is stored under a word that best describes it to the user, the user will be able to easily search and retrieve for it at a future date. By adding an editable search key and enhance data storage to OT Application, the user can create relational database search and reports on the contents of what was send and/or received in text messages.

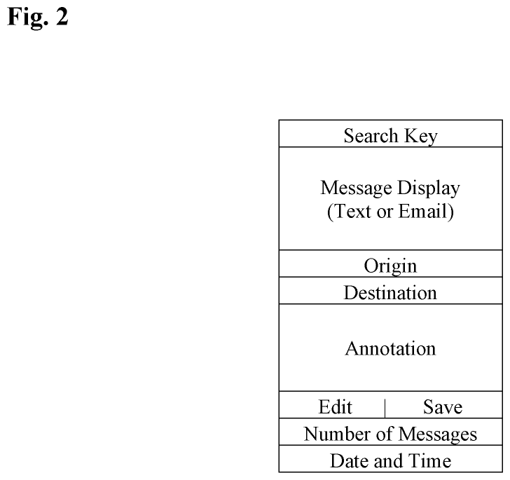

In FIG. 2, we shows the SeachKey field, Message Field, Annotation Field and the Edit and save buttons. The user can enter an alphanumeric string into the Searchkey Field of any record, and then do a search of the entire table of stored messages and get only message with a matching alphanumeric character string in the Searchkey field. Since the Searchkey is not part of the message, the search result is control by the user, only records with the alphanumeric string that they save to the Searchkey field will be return as results of the search. This enable the user to create a relationship between any desired message regardless of its origin. In effect the use has created a mono-relational table (MRT). A MRT is a database table in which user define relations are created between records that do not necessarily have anything common to one another other than the user desire to relate them.

In one embodiment, the text message and email can be displayed in either mixed together or separated by type: email & text message. It would be possible to display email and text messages mixed together by allowing the text messages to look up the name and email of the sender and store it in a field of the record, or allow the email to look up the phone number of the party the mail is addressed to using the mobile device contact database and store that information into a field in the table (i.e. the “LinkKey_Phone” and “LinkKey_Email” field). A contact list on a mobile device typically containing the name, phone number and email address of the contacts. The Application would take an email sender's address and look it up in the Contact list, and if found the Application would take the associated phone number and place it in the Linking_Key field. This process will allow all email to be able to be associated with the text messages that come from the same location. The reverse can be done for text messages, where the Contact list is used to look up phone numbers to be placed in the “Linking_Key” field of received emails.

In an alternative embodiment, the “Communication Type” (a.k.a. MType) field can be used to allow the mobile device user to search, view, and annotate only email or only text messages at a time. When a message is first captured, the capture method will tag the message to indicate which process was used to capture said message: “Text” for text message process and “Email” for email process. The user can use the “Communication Type” field to selectively search, view, and annotate only email messages stored in records in the table, search, view, and annotate only text messages stored in the records in a table (Emails vs Text Messages), or do both email and text messages.

FIG. 1 is a prototype listing of fields of a record that is used to store individual sent and received emails and text messages.

FIG. 2 is representative of the OT Application screen on mobile device.

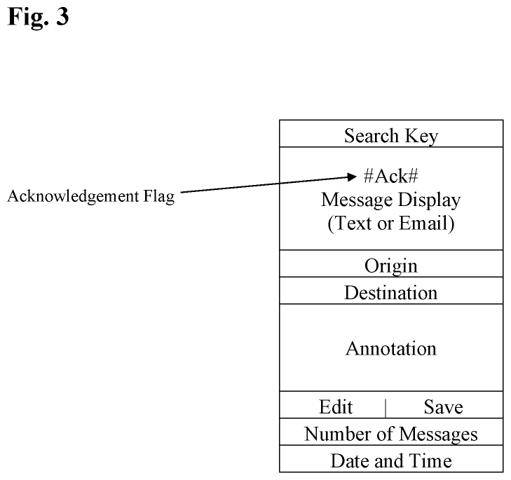

FIG. 3 is representative of a text message with a trigger for sending an acknowledgement text message to the sender of a email.

1. A method for enriching the value of an email or a text message stored in fields of a record of a table in a database on a mobile device comprising: software on a mobile device for capturing, converting and storing individual sent and received text messages or received email in specific fields of a record in a table of a database, and the said record's fields being accessible on the mobile device for editing, searching, and displaying.

2. The method of claim 1, wherein the messages stored on the mobile device can be all emails, all text messages, or a combination of both emails and text messages stored on said mobile device.

3. The method of claim 1 wherein some of the records in the table in the database on the mobile device can be made relational to one another regardless of the stored message content or origin of said message by entering a user entering a shared alphanumeric character string in a specific editable field of selected records and subsequently execute a search for said shared alphanumeric character string in said table in said database.

4. The method of claim 2 wherein a received message converted and stored in the said fields of a record of said mobile device can trigger an action on said receiving mobile device.

5. The method of claim 4 wherein a received message from multiple email accounts, email platform, and text messages can be viewed on the same screen in the same

6. The method of claim 5 wherein a received email messages text messages can be search at the same time using a single criterion or multiple criteria.

7. The method of claim 6 wherein a segment of a received email or text message can be viewed as a preview to the content of the full message to give a shorten version of said message content for user determination of interest in the total message.
